(19) United States
(12) Patent Application Publication
(10) Pub. No.: US 2020/0198200 A1
(43) Pub. Date: Jun. 25, 2020

(54) INJECTION MOLDING APPARATUS

(71) Applicant: MOLD-MASTERS (2007) LIMITED, Georgetown (CA)

(72) Inventors: Denis BABIN, Georgetown (CA); Baltej PANNU, Brampton (CA)

(21) Appl. No.: 16/613,373

(22) PCT Filed: May 11, 2018
(86) PCT No.: PCT/CA2018/050559

§ 371 Date: Nov. 13, 2019

Related U.S. Application Data
(60) Provisional application No. 62/506,010, filed on May 15, 2017.

(51) Int. Cl. B29C 45/23; B29C 45/64

(52) U.S. Cl. CPC B29C 45/23; B29C 45/64

(57) ABSTRACT

An injection molding apparatus includes an injection unit; a clamping unit; a mold assembly including a mold plate, a manifold, an actuator mounted on and upstream of the manifold, and at least one nozzle coupled to and downstream of the manifold, the actuator for reciprocating a valve pin between an open position allowing a melt to pass through the nozzle and a closed position preventing the melt from passing through the nozzle, the mold assembly further including a biasing mechanism biasing the actuator upstream towards the mold plate.

### FIELD

The invention relates generally to an injection molding apparatus and, in particular, to an injection molding apparatus having an actuator biased against a mold plate.

### BACKGROUND

Injection molding heats a material (e.g., plastic) into a melt, injects the melt into a mold, and, after the melt cools and forms a solid article in the mold, ejects the article from the mold. Typically, an injection molding apparatus comprises heated components that are kept at the operating temperature of the melt, a requirement that presents challenges to components with an operating temperature below the operating temperature of the melt.

### BRIEF SUMMARY

In an illustrated embodiment, an injection molding apparatus is provided. The injection molding apparatus comprises: an injection unit; a clamping unit; a mold assembly including a mold plate, a manifold, an actuator mounted on and upstream of the manifold, and at least one nozzle coupled to and downstream of the manifold, the actuator for reciprocating a valve pin between an open position allowing a melt to pass through the nozzle and a closed position preventing the melt from passing through the nozzle, the mold assembly further including a biasing mechanism biasing the actuator upstream towards the mold plate.

### BRIEF DESCRIPTION OF THE DRAWINGS

FIG. 1 is a schematic view of an injection molding apparatus, according to an embodiment of the present application.

FIG. 2 is a schematic view of a mold assembly of FIG. 1, according to an embodiment of the present application.

FIG. 3 is perspective view of an actuator of FIG. 2, according to an embodiment of the present application.

FIG. 4 is a top view of the actuator of FIG. 3.

FIG. 5 is a sectioned view of the actuator of FIG. 4 taken along the line A-A with the mold plate secured in position.

FIG. 6 is a sectioned view of the actuator of FIG. 4 taken along the line A-A without the mold plate.

FIG. 7 is a sectioned view of the actuator of FIG. 4 taken along the line B-B.

FIG. 8 is a sectioned view of the actuator of FIG. 4 taken along the line B-B.

FIG. 9 is a sectioned view of the actuator of FIG. 4 taken along the line A-A including a lateral extension according to another embodiment of the present application.

FIG. 10 is a sectioned view of the actuator of FIG. 4 taken along the line A-A including a heat reflector according to yet another embodiment of the present application.

FIG. 11 is a sectioned view of the actuator of FIG. 4 taken along the line A-A according to yet another embodiment of the present application.

### DETAILED DESCRIPTION

Specific embodiments of the present application are now described with reference to the figures. The following detailed description is merely exemplary in nature and is not intended to limit the concepts and uses of the concepts. Furthermore, there is no intention to be restricted by any expressed or implied theory in the present disclosure. In the description, “downstream” is used with reference to the direction of the moldable liquid flow from an injector to a mold cavity, and also with reference to the order of components, or features thereof, through which the mold material flows from the injector to the mold cavity, whereas “upstream” is used with reference to the opposite direction.

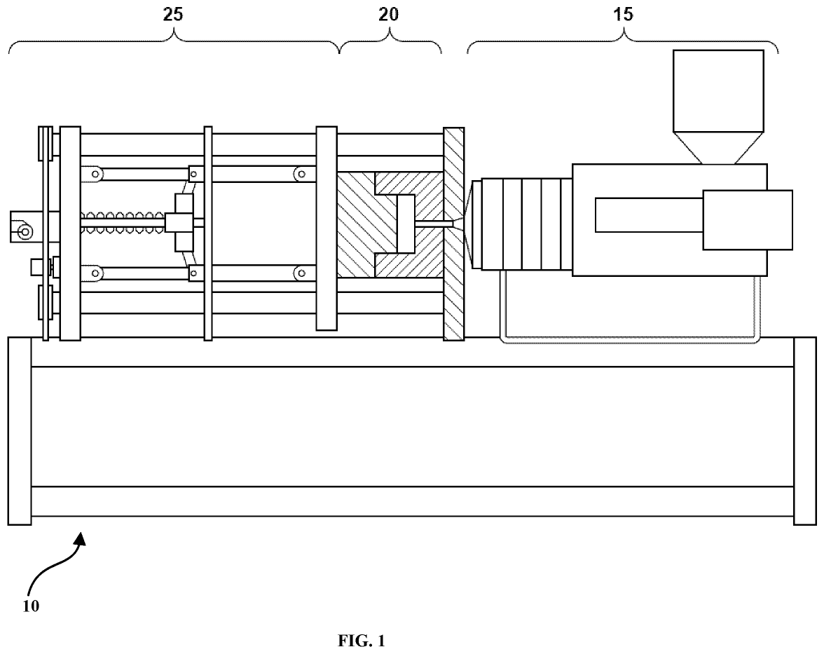

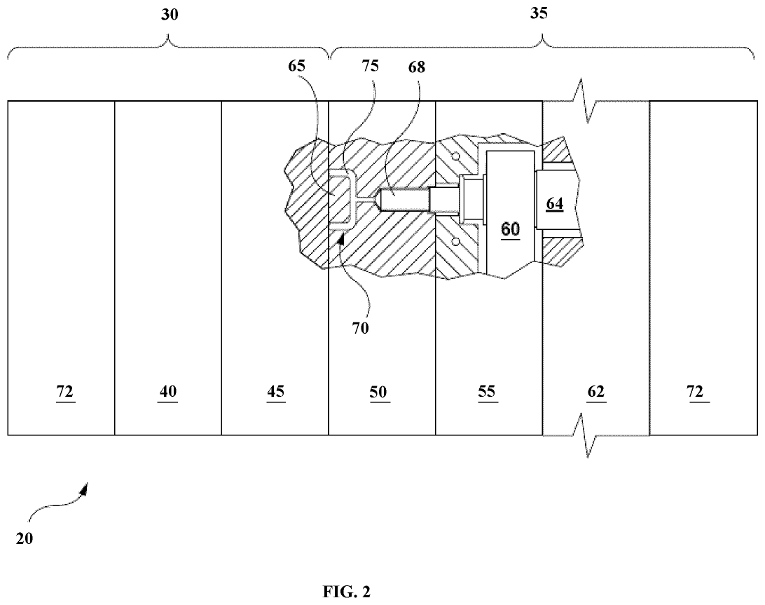

FIG. 1 is a schematic side view of an injection molding apparatus 10 comprising: an injection unit 15, a mold assembly 20, and a clamping unit 25. Referring to FIG. 2, mold assembly 20 includes a moving half 30 and a stationary half 35. Clamping unit 25 is configured to move moving half 30 towards stationary half 35 to close mold assembly 20 and away from stationary half 35 to open mold assembly 20. Moving half 30 includes a core plate 40 and a stripper plate 45. Stationary half 35 includes a cavity plate 50, a manifold plate 55 housing a manifold 60, and, depending on the application of injection molding apparatus 10, other plates 62. Mold assembly 20 is bounded by a clamp plate 72 on each end thereof (see FIG. 2). (Persons skilled in the art would appreciate that, depending on the application, some plates can be combined into one plate. For example, clamp plate 72 can be combined with core plate 40.)

Mold assembly 20 comprises a plurality of nozzles 68 (and will henceforth be referred to individually as nozzle 68 and collectively as nozzles 68). Manifold 60 is a melt delivery body, which, depending on the application of injection molding apparatus 10, can include a network of melt channels (not shown) for distributing melt from injection unit 15 to nozzles 68. Core plate 40 includes a plurality of cores 65. Cavity plate 50 includes a plurality of cavities 70 (and will henceforth be referred to individually as cavity 70 and collectively as cavities 70).

In operation, clamping unit 25 closes mold assembly 20 and clamps mold assembly 20 shut, in a closed position, to prevent mold assembly 20 from opening under the pressure of melt being injected, by injection unit 15, into cavities 70. With mold assembly 20 clamped in the closed position, melt is injected in to a space 75, shaped and dimensioned to create an article (not shown), between core 65 and corresponding cavity 70. When the article is ready to depart mold assembly 20, the article clings to core 65. To remove the article from core 65, mold assembly 20 opens allowing stripper plate 45 to move upstream to eject the article from core 65.

Mold assembly 20 comprises manifold 60 housed in manifold plate 55, a mold plate 100 upstream and in contact with manifold plate 55, and an actuator 64 mounted on and upstream of manifold 60, between mold plate 100 and manifold 60. Mold plate 100 is actively cooled by cooling lines 101. In some embodiments, mold plate 100 is clamp plate 72. In some embodiments, mold assembly 20 comprises a plurality of actuators 64 (and will henceforth be referred to individually as actuator 64 and collectively as actuators 64).

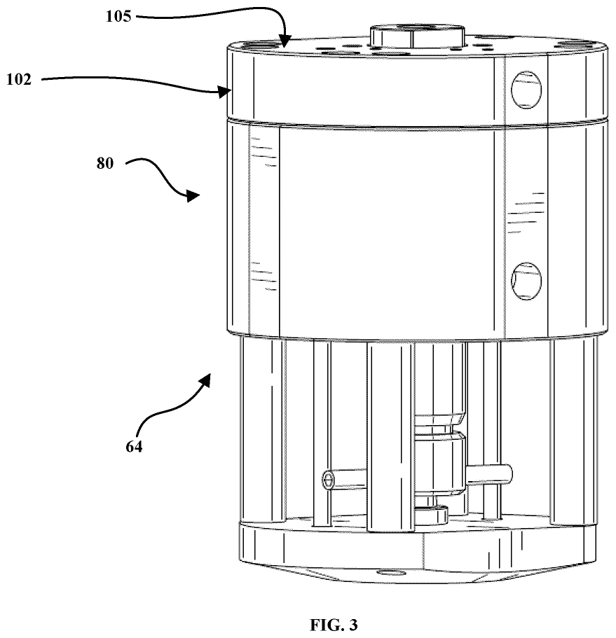

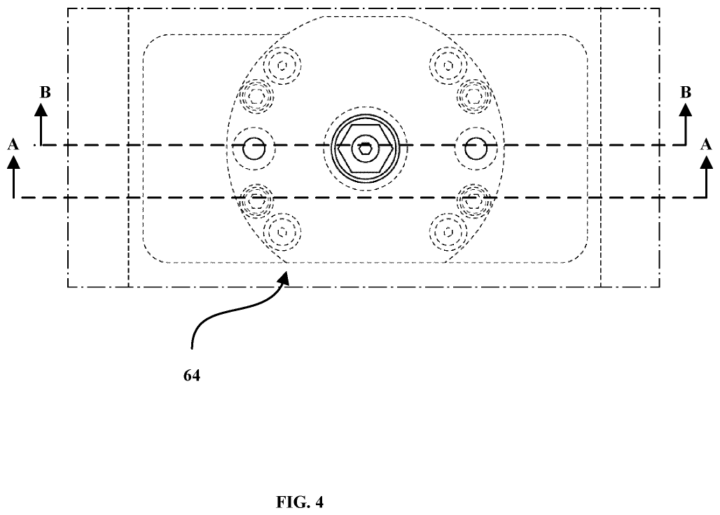

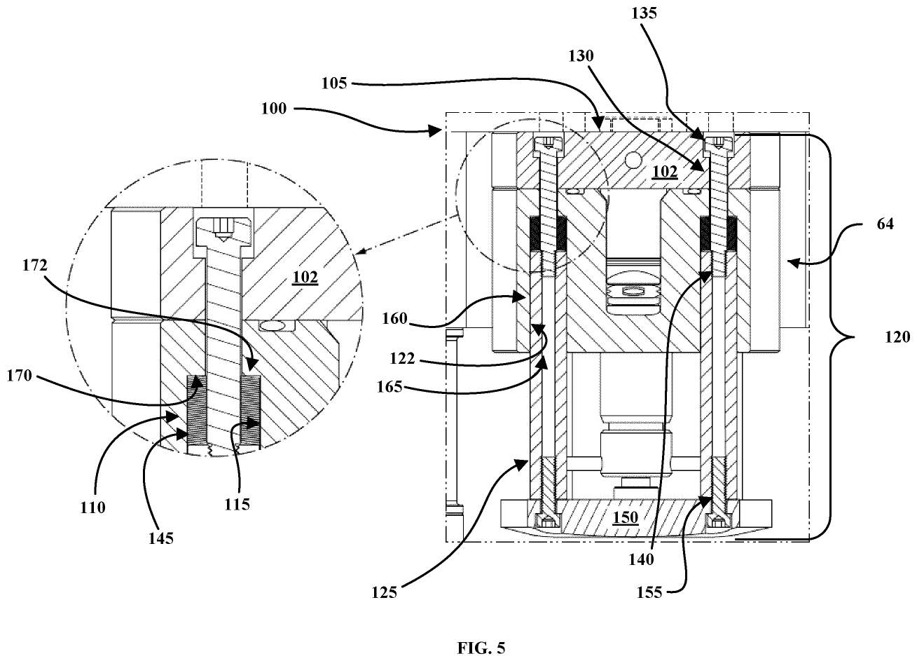

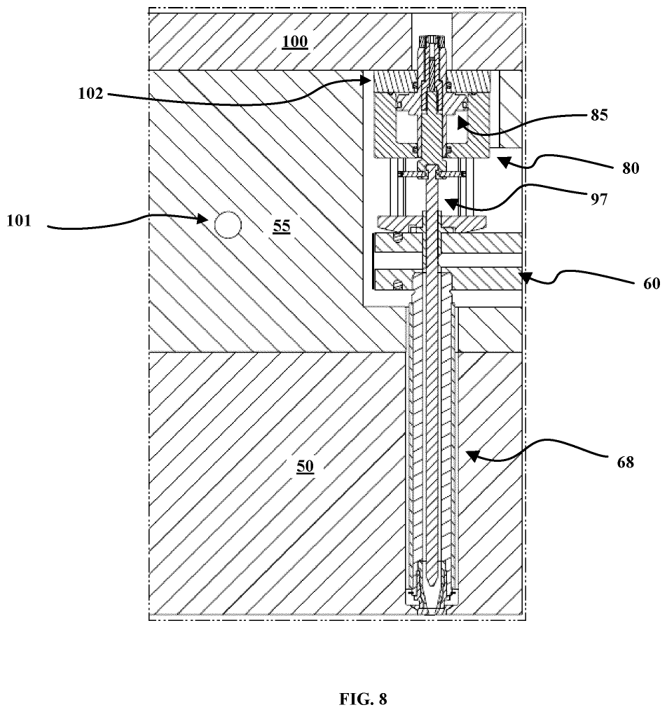

FIG. 3 and FIG. 4 are a perspective and top view, respectively, of actuator 64 according to an embodiment of the present application. Actuator 64 comprises a housing 80 and a piston 85 (see FIG. 8) housed in housing 80. Actuator 64 is for reciprocating a valve pin 97 (see FIG. 8) between an open position and a closed position. In the open position, valve pin 97 allows a melt (not shown) to pass through nozzle 68. Nozzle 68 is coupled to and downstream of manifold 60 (see FIG. 8). In the closed position valve pin 97 prevents the melt from passing through nozzle 68. Housing 80 includes a cap 102 having an upstream surface 105 (see FIG. 3 and FIG. 5). (In some embodiments, upstream surface 105 can be integral with housing 80.) Mold assembly 20 further includes a biasing mechanism 110 biasing upstream housing 80 upstream towards mold plate 100. In the embodiment illustrated by FIG. 5, biasing upstream housing 80 upstream towards mold plate 100 includes biasing surface 105 in contact with mold plate 100.

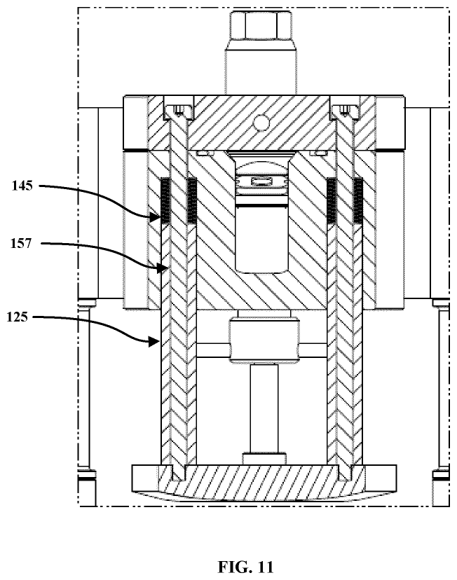

Housing 80 includes a plurality of bores 115 spanning the length of housing 80. Mold assembly 20 further includes a plurality of fasteners 120, each fastener 120 passing though a respective bore 115, coupling housing 80 to manifold 60. Fasteners 120 are dimensioned to space radially from a wall 122 of bores 115 (i.e., circumferential surfaces of fasteners 120 do not touch wall 122 of bores 115). Consequently, housing 80 is longitudinally displaceable relative to fasteners 120. Each fastener 120 includes a nut 125 and a bolt 130 having a head 135 and a threaded end 140 distal from head 135 threadably secured to nut 125. Biasing mechanism 110 includes a biasing member 145, with bolt 130 passing through biasing member 145, positioned between nut 125 and housing 80. Nut 125 is supported by manifold 60 via a valve disc flange 150. Valve disc flange 150 is connected to nut 125 via a bolt 155. In the embodiment illustrated by FIG. 11, bolts 130 and 155 are replaced by a shoulder bolt 157, which is threadably connected to valve disc 150. (In the illustrated embodiments, biasing member 145 is a disc spring but a person of relevant ordinary skills in the art would appreciate that biasing member 145 can be other forms of biasing mechanisms such as a compression spring.)

Bore 115 partially houses a respective nut 125, and includes an end portion 160 having an opening 165 proximal to manifold 60, and a shoulder 170. A respective biasing member 145 is retained between shoulder 170 and nut 125 (i.e., every bore 115 houses a biasing member 145 positioned between shoulder 170 and nut 125).

Housing 80 contacts fasteners 120 via biasing members 145. In operation, heat from manifold 60 can travel upstream via fasteners 120. The heat can then be transferred to housing 80 via at least an upstream surface 172 of biasing member 145 (see FIG. 5). Having upstream surface 105 of actuator 64 in contact with mold plate 100 can reduce the heat accumulated in housing 80 by transferring the heat in housing 80 to mold plate 100, especially, if mold plate 100 is actively cooled with, for example, cooling lines 101 (such as water lines). Reducing the temperature of actuators 64 can increase the lifespan of components, such as piston o-rings 174, within actuators 64.

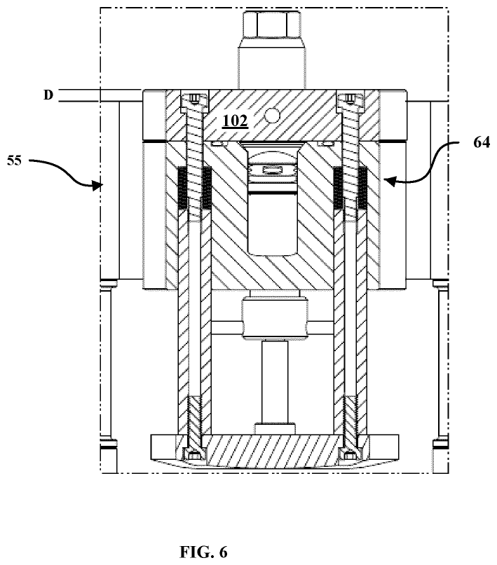

As illustrated in FIG. 5, once mold plate 100 is secured in place, upstream surface 105 is biased into contact with mold plate 100 via biasing members 145. FIG. 6 illustrates the condition prior to installation of mold plate 100 with upstream surface 105 upstream of manifold plate 55 by a gap “D”. Installing mold plate 100 onto manifold plate 55 compresses biasing member 145 and, by extension, housing 80 into manifold plate 55 into the state illustrated in FIG. 5 with biasing member 145 urging upstream surface 105 against mold plate 100.

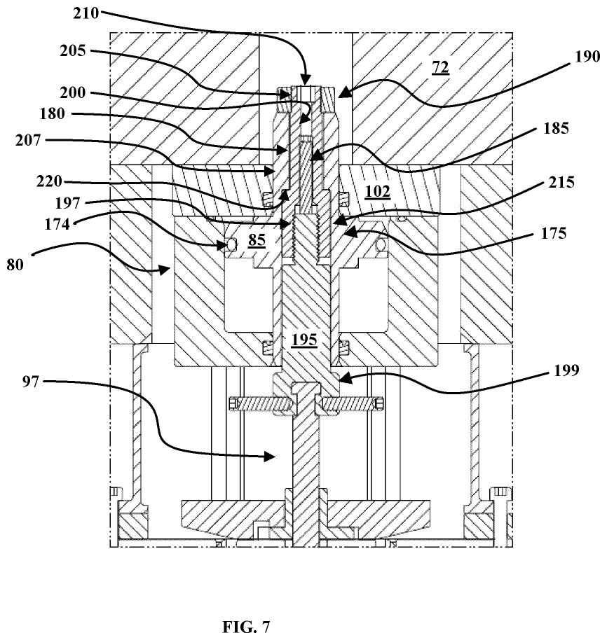

FIG. 7 illustrates an embodiment of the actuator 64 comprising a valve pin coupler 175. Valve pin coupler 175 comprises a piston insert 180, a set screw 185, a nut 190, and a valve pin holder 195 including a first end 197 and a second end 199. Valve pin holder 195 is threadably connected to piston insert 180 at first end 197 and is coupled to valve pin 97 at second end 199. Set screw 185 is threadably connected to an internally threaded bore 200 of piston insert 180. Nut 190 is threadably connected to an externally threaded end 205 of piston insert 180. Piston insert 180 is housed in and rotatable relative to a hollow extension 207 of piston 85. Piston insert 180 further includes a non-circular bore 210 at externally threaded end 205 in communication with internally threaded bore 200. In some embodiments, non-circular bore 210 has a hexagonal cross-section. However, a person of ordinary relevant skills in the art would appreciate that other shapes (such as D-shape) can also be used.

The axial distance of valve pin 97 relative piston 85 can be varied by rotating piston insert 180 relative to valve pin holder 195 via, for example, rotation of a tool inserted into non-circular bore 210. Once valve pin 97 is at a desired distance from piston 85, set screw 185 can be tightened against valve pin holder 195 to prevent valve pin holder 195 from rotating relative to piston insert 180, then nut 190 can be tightened against extension 207 of piston 85 to prevent piston insert 180 from rotating relative to extension 207. Tightening nut 190 against extension 207 also pulls a lower portion 215 of piston insert 180 against a shoulder 220 of extension 207.

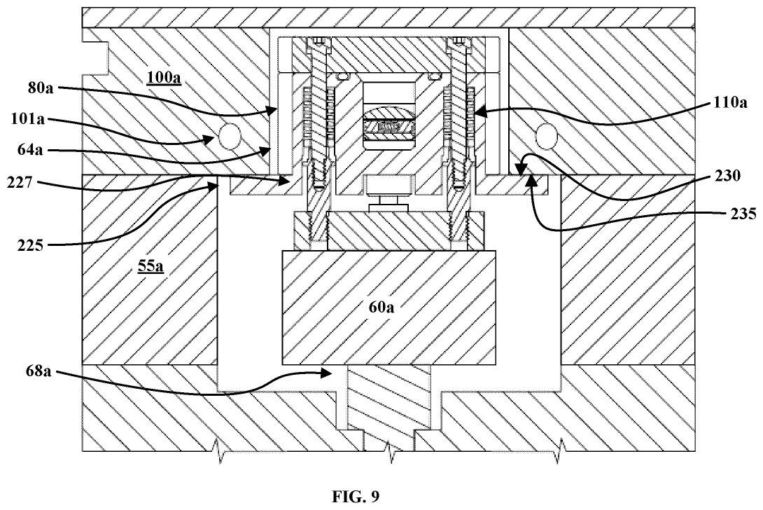

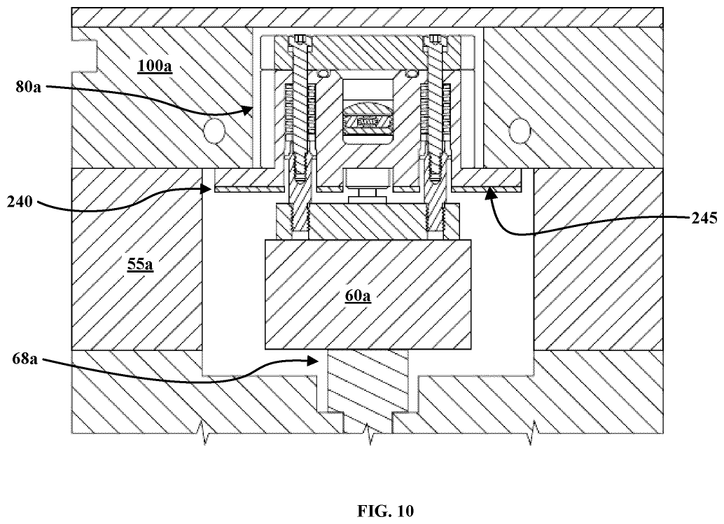

FIG. 9 illustrates another embodiment of actuator 64 of FIG. 3, referenced as actuator 64a. The reference numbers used in FIG. 3 are used to identify like components in FIG. 9. Components of actuator 64a that are alternatives to their respective counterpart components of actuator 64 bear the same reference number as their counterpart components except suffixed by the letter “a”. Actuator 64a differs from actuator 64 in that actuator 64a includes a lateral extension 225 at a downstream end 227 of housing 80a. Lateral extension 225 is integral with housing 80a. Biasing mechanism 110a biases an upstream surface 230 against a downstream surface 235 of mold plate 100a. In some embodiments such as the embodiment illustrated by FIG. 10, housing 80a includes a heat reflector 240 at a downstream surface 245 of housing 80a reducing heat absorption by housing 80a from ambient heat. Heat reflector 240 can be chrome plated or nickel plated to produce a highly polished surface.

While various embodiments according to the present application have been described above, it should be understood that they have been presented by way of illustration and example only, and not limitation. It will be apparent to persons of ordinary relevant skills in the relevant art that various changes in form and detail can be made therein without departing from the scope of the invention. It will also be understood that each feature of each embodiment discussed herein, may be used in combination with the features of any other embodiment, for example, heat reflector 240 can also be included in the embodiment illustrated by FIG. 5 and shoulder bolts 157 can also be used in the embodiments illustrated by FIGS. 9 and 10. Thus, the breadth and scope of the present invention should not be limited by the above-described exemplary embodiments, but should be defined only in accordance with the appended claims and their equivalents.

1. An injection molding apparatus comprising:
an injection unit;
a clamping unit; and
a mold assembly including
a mold plate,
a manifold,
an actuator mounted on and upstream of the manifold,
at least one nozzle coupled to and downstream of the manifold, wherein the actuator is configured to reciprocate a valve pin of the nozzle between an open position allowing a melt to pass through the nozzle and a closed position preventing the melt from passing through the nozzle, and
a biasing mechanism configured to bias the actuator upstream towards the mold plate.

2. The injection molding apparatus of claim 1, wherein the actuator includes an actuator housing having an upstream surface and wherein the biasing mechanism is configured to bias the upstream surface of the actuator housing into contact with the mold plate.

3. The injection molding apparatus of claim 1, wherein the actuator includes an actuator housing having a lateral extension at a downstream end of the actuator housing and wherein the biasing mechanism is configured to bias an upstream surface of the lateral extension of the actuator housing into contact with the mold plate.

4. The injection molding apparatus of claim 2, wherein the actuator housing includes a plurality of bores spanning a length of the actuator housing, and the mold assembly further includes a plurality of fasteners, each of the fasteners passing through a respective one of the bores to couple the actuator housing to the manifold, and wherein the actuator housing is longitudinally displaceable relative to the fasteners.

5. The injection molding apparatus of claim 4, wherein each of the fasteners includes a nut and a bolt having a head and a threaded end distal from the head threadably secured to the nut, the biasing mechanism including a biasing member for each of the fasteners, positioned between the nut and the actuator housing, the nut supported by the manifold.

6. The injection molding apparatus of claim 5, wherein each of the plurality of bores partially houses a respective one of the nuts, and includes an end portion having an opening proximal to the manifold and a shoulder, a respective one of the biasing members retained between the shoulder and the nut.

7. The injection molding apparatus of claim 6, wherein the mold plate is a clamp plate.

8. The injection molding apparatus of claim 7, wherein the actuator housing includes a heat reflector at a downstream end of the actuator housing.

9. The injection molding apparatus of claim 8, wherein the heat reflector is chrome plated.

10. The injection molding apparatus of claim 8, wherein the heat reflector is nickel plated.

11. The injection molding apparatus of claim 8, wherein the biasing mechanism includes a disc spring.

12. The injection molding apparatus of claim 3, wherein the actuator further comprises a piston and a pin coupler for coupling the valve pin to the piston, the valve pin coupler for adjusting an axial distance of the valve pin relative to the piston.

13. The injection molding apparatus of claim 12, wherein the valve pin coupler includes a piston insert, a set screw, a nut, and a valve pin holder including a first end and a second end; the valve pin holder is threadably connected to the piston insert at the first end and is coupled to the valve pin at the second end; the set screw is threadably connected to an internally threaded bore of the piston insert; the nut is threadably connected to an externally threaded end of the piston insert; and the piston insert is housed in and rotatable relative to a hollow extension of the piston.

14. The injection molding apparatus of claim 13, wherein the piston insert further includes a non-circular bore at the externally threaded end in communication with the internally threaded bore.

15. The injection molding apparatus of claim 3, wherein the actuator housing includes a plurality of bores spanning a length of the actuator housing, and the mold assembly further includes a plurality of fasteners, each of the fasteners passing through a respective one of the bores to couple the actuator housing to the manifold, and wherein the actuator housing is longitudinally displaceable relative to the fasteners.

16. The injection molding apparatus of claim 15, wherein each of the fasteners includes a nut and a bolt having a head and a threaded end distal from the head threadably secured to the nut, the biasing mechanism including a biasing member for each of the fasteners, positioned between the nut and the actuator housing, the nut supported by the manifold.

17. The injection molding apparatus of claim 16, wherein each of the plurality of bores partially houses a respective one of the nuts, and includes an end portion having an opening proximal to the manifold and a shoulder, a respective one of the biasing members retained between the shoulder and the nut.

18. The injection molding apparatus of claim 17, wherein the mold plate is a clamp plate.

19. The injection molding apparatus of claim 18, wherein the actuator housing includes a heat reflector at a downstream end of the actuator housing.

20. The injection molding apparatus of claim 19, wherein the heat reflector is one of chrome plated or nickel plated.
